(19) United States
(12) Patent Application Publication
(10) Pub. No.: US 2009/0082988 A1
(43) Pub. Date: Mar. 26, 2009

(54) NON-ORTHOGONAL MONITORING OF COMPLEX SYSTEMS

(75) Inventors: Gordon R. Jones, Liverpool (GB); Joseph William Spencer, Liverpool (GB); Paul Samuel Dodds, Wrexham (GB)

Correspondence Address: BLAKELY SOKOLOFF TAYLOR & ZAFMAN LLP, 1279 OAKMEAD PARKWAY, SUNNYVALE, CA, 94085-4040, US

(73) Assignee: THE UNIVERSITY OF LIVERPOOL, Liverpool (GB)

(21) Appl. No.: 11/547,437

(22) PCT Filed: Mar. 18, 2005
(86) PCT No.: PCT/GB2005/001049

§ 371 Date: Nov. 21, 2008

(30) Foreign Application Priority Data
Mar. 31, 2004 (GB) 0407267.4

(51) Int. Cl. G01J 3/46; G06F 15/00

(52) U.S. Cl. 702/127; 356/402

(57) ABSTRACT

Apparatus for non-orthogonal monitoring of a variable measurand in a system or process, comprising: means defining at least three sources having limited spectral widths and non-orthogonal spectral outputs; a modulator means which is adapted to modulate the outputs of said sources in response to said variable measurand; at least three detectors which have non-orthogonal responsivities in the measurement domain and which receive the modulated outputs of said sources; and a processor which converts the detector outputs algorithmically into primary chromatic parameters.

The present invention is concerned with the monitoring of complex systems wherein their behaviour and/or physical/chemical condition are to be assessed. In particular, the present invention concerns monitoring of complex systems using non-orthogonal response characteristics in signal processors.

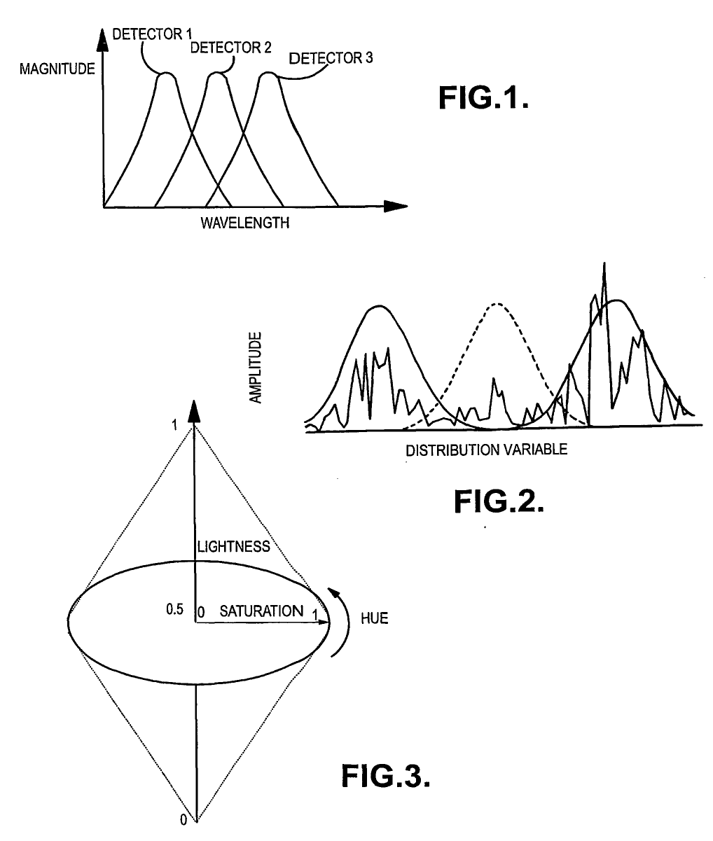

A “non-orthogonal” system is one wherein the responses of processors e.g. detectors, in a signal domain (e.g. optical wavelength) overlap, as illustrated in FIG. 1 of the accompanying drawings. As evident from FIG. 1, as a result of the overlapping in the signal tails, the outputs of the detectors are cross-correlated, yielding higher sensitivity to signals in the tails.

In principle, the signal processors used in non-orthogonal monitoring systems described herein will be responsive in a particular signal domain. The signal domain may be any of a plurality of conventional signal domains, including optical, acoustic, infra-red and radio, each addressed in the frequency (wavelength) or time domains. Additionally, other domains such as spatial location, mass (chemical), and non-orthogonality between specific parameters (e.g. pressure and temperature etc) plus combinations of large numbers of sensor types can be accommodated. However, most of the examples described herein are based on the situation where the monitoring signal domain is essentially optical, including IR, and monitoring is achieved by detecting chromatic changes (chromaticity processing).

Chromatic processing is the name given to the application of sets of non-orthogonal weighted integrals to distributed measurements and the subsequent transformation of the integral quantities obtained to give parameters summarising certain characteristics of the distribution. The name derives from the methods' origins in broadband optics and colour science, where the distribution to which it is applied is that of light intensity across the optical spectrum. However, it is applicable to measurements of any quantity distributed across another variable (for example, acoustic intensity with frequency or temperature with spatial position). Where the N integral weightings take the form of Gaussian curves (FIG. 2) the quantities derived in the first part of the process are the values of the first N basis functions of a Gabor expansion of the original signal. It has also been shown that this process is optimally information preserving for the general signal and that useful information retention with high robustness to noise is obtainable with as few as three Gaussian integrals.

In the optical domain an approximation to these three Gaussian basis functions is provided by the wavelength response of the sensor elements e.g. colour photo detectors (eg. in CCD cameras). This is known as a tristimulus sensor system. Observations may therefore be represented as data points in a colour space, the most straightforward of which is a Cartesian colour cube having an axis for each of the three sensor elements. The three co-ordinates of a point therefore give a separate measure of each of the familiar red, green and blue components of visible light. Thus, where the original data is a visible spectrum, these axes correspond to the familiar red, green and blue components of a colour and such colour terminology is often applied by analogy where other distribution variables and measures and are involved to aid interpretation.

The second stage in chromatic processing (which may, in some circumstances, be omitted, or, where there are only a few discrete values of the distribution variable, be used on its own) is the transformation of the Cartesian colour space into a space referenced by a new set of parameters. These new parameters are formed by the combination of the tristimulus parameters according to the formulae that describe the transformation. Several such transformations are established in colour science, but one in particular has been found to be especially useful for the combination that it makes to operator interpretability of information through its partitioning into components of distinct character. This is the transformation to HLS (Hue, Lightness, Saturation) space. By way of example only, the transformation can be:

$$\begin{matrix}H = \{ \begin{matrix}\frac{60 ( G - B )}{( max ( R , G , B ) - min ( R , G , B ) )} if max ( R , G , B ) = R \\ \frac{60 ( 2 + ( B - R ) )}{( max ( R , G , B ) - min ( R , G , B ) )} if max ( R , G , B ) = G \\ \frac{60 ( 4 + ( R - G ) )}{max ( R , G , B ) - min ( R , G , B ) )} if max ( R , G , B ) = B\end{matrix} & ( 1 ) \\ L = \frac{R + G + B}{3} & ( 2 ) \\ S = \frac{max ( R , G , B ) - min ( R , G , B )}{max ( R , G , B ) + min ( R , G , B )} & ( 3 )\end{matrix}$$

where R, G and B are the red, green and blue parameters of the Cartesian space, and H, L and S are the hue, lightness and saturation components of the new space.

Hue is specified as an angle (given in degrees by the above formula) and the lightness and saturation parameters range from 0 to 1, giving a cylindrical polar space of unit radius and axial extent (FIG. 3). These parameters partition the information acquired such that lightness corresponds to the total amplitude of the original measurements summed across the range of their distribution variable, saturation corresponds to the degree to which the measurements are spread throughout the range of the distribution and hue corresponds to the value of the distribution variable about which the measurements are spread. The parameter names reflect the interpretation of these characteristics familiar from colour perception. Where the measurements are of quantities other than visible light, physically analogous and informatically identical (but for some small departure of our colour receptors from a Gaussian response) processing provides an intuitive assimilation of the information represented.

Chromaticity monitoring has relied conventionally upon the non-orthogonality of plural optical detectors for classifying detected signals. In this connection, colour (which is a human perception) may be regarded as a special case of chromaticity, whereas chromaticity may itself be regarded as a special case within the more general area of non-orthogonal signals discrimination.

Each detected signal has a special signature which may be classified by N defining processors. In general such signatures form highly non-linearly related sets requiring the need for at least N=3 defining processors for classification in signal space (tri-stimulus processing). (The use of N=2 processors (distimulus) constitutes a linear approximation in two dimensional signal space).

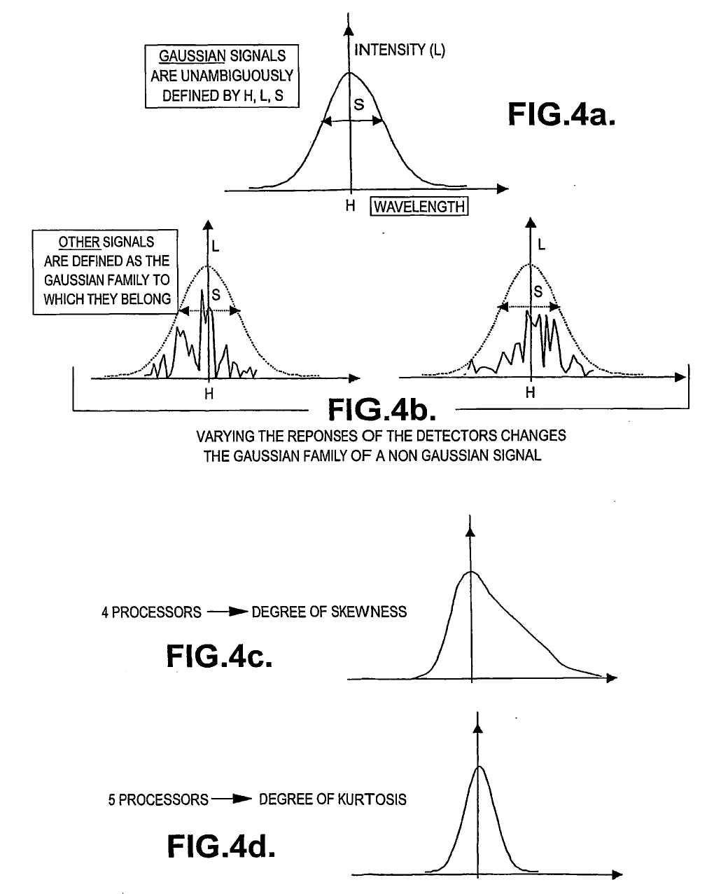

The compressed spectral signature may take the form of processors taken from various signal-defining methodologies such as for instance orthogonal (e.g. Fourier Transformed) or non-orthogonal (e.g. chromatic) parameters etc. By way of example, if it is assumed that all signals are Gaussian distributions of variable signal strength with respect to the signal domain (e.g. wavelength, frequency, time etc), classes of signals are then unambiguously defined by only N=3 processors corresponding to (see FIG. 4a):—
Signal amplitude (or power content) (L)
Location of the peak value in signal parameter space (H)
Signal half width (S)

If the need for all signals to be Gaussian in nature is relaxed, then each signal may be allocated to one only of a class governed by a mother Gaussian. This provides a substantial but not absolute signal discrimination means through the use of only three detectors (R,G,B,) to yield three functions H,L,S. This forms the basis of chromatic discrimination: if the forms of the R,G,B detectors correspond to the responsitivities of the human eye, the N the chromaticity degenerates into the special case of colour. H,L,S are the N the Hue, Lightness; and Saturation of colour science as described above.

Extension of the use of N>3 processors leads to a subdivision of each mother Gaussian class into additional non-Gaussian classes (see FIG. 4b). By way of an example, N=4 may define the degree of asymmetric deviation (Skewness) from a Gaussian distribution (see FIG. 4c) i.e. each Gaussian class N_{g} subdivides into several asymmetric Gaussians

$${\sum }_{s = 1}^{x} {n}_{s}$$

with x being determined by the signal processor discrimination. Furthermore an extension to N=5 parameters enables the degree of Kurtosis of the Gaussian distribution to be determined (see FIG. 4d) leading to a further subdivision of each asymmetric Gaussian class into

$${\sum }_{K = 1}^{y} {h}_{k}$$

subclasses.

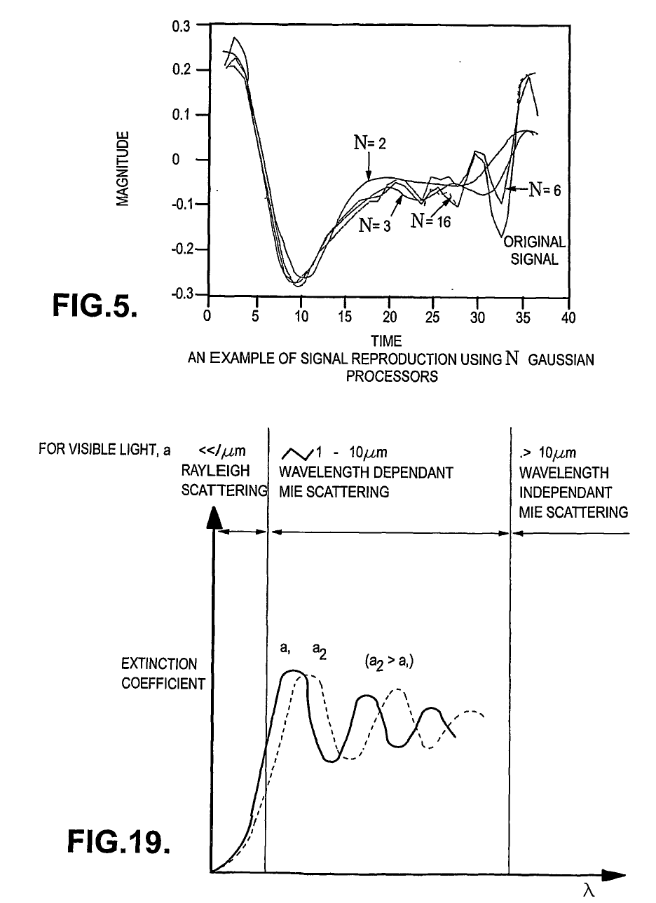

As explained hereinbefore, tristimulus chromatic processing (N=3) is a special case of the more general situation represented by the Gabor transform whereby a general number N of detectors might be utilized. The possibility of optimizing the number of detectors utilized for particular situations has been considered already, computer-based simulations having been performed to investigate how well a particular time varying signal of finite duration might be reconstituted from a Gabor series expansion for various numbers of detectors. A typical signal waveform used in such a simulation is shown in accompanying FIG. 5 together with reconstituted waveforms for N=2 (distimulus), 3 (tristimulus), 6 and 16. These results show that, with a distimulus system, a broad indication of the overall signal profile is obtained; a tristimulus system provides in addition a reasonable approximation to some of the finer details of the signal; N=6 produces a very good signal replica whilst N=16 gives little improvement over the N=6 case. It may therefore be concluded that N=6 corresponds to an optimum condition for signal discrimination (giving better than 95% signal reproducibility) whilst a tri stimulus system gives an acceptable performance for many applications (consistent with the usefulness of colour vision).

Thus, although the extent of signal identification improves as N increases and N could in principle be any number, as illustrated in FIG. 5 of the accompanying drawings, in practice it has been found that a maximum value of N=6 (2≦N≦6) provides sufficient signal class discrimination for an extremely high proportion of real signals.

Thus the number of signal classes increases non-linearly and substantially as N increases from 3 to 6 so providing a high degree of signal discrimination capability with only an economic increase in the number of processors and processing required.

Number of signals classes

$${M}_{T} = {M}_{N} \cdot {\sum }_{s = 1}^{x} {n}_{s} \cdot {\sum }_{k = 1}^{y} {h}_{k} \qquad ( 1 )$$

This therefore represents a major discrimination of higher order non-orthogonal monitoring from the special cases of chromaticity or colour. In general, the use of N>3 non-orthogonal processors leads to further signal defining parameters other than H,L,S. For example, the Skewness of a signal (see FIG. 4c) may be described by the additional parameter

S_{K}=(^{x}_{MED1}−^{x}_{MED2})/(^{x}_{MED1}+^{x}_{MED2})

where (^{x}_{MED1}, ^{x}_{MED2}) are processor outputs which do not yield either maximum or minimum values.

Thus, it is advantageous if the number of monitoring elements N can be increased to N>3 and preferably to N≦6.

Conventionally, in applying non-orthogonal monitoring as described above, the signal processors having the non-orthogonal characteristics have been the detectors. However, there are practical difficulties in realising a 6 or more detector system with high efficiency. For example, bifurcating optical fibres into six separate measurement channels is optically inefficient and realising six detectors with appropriate non-orthogonal properties is difficult physically.

It is one object of the present invention to extend non-orthogonal monitoring technique to further areas.

In accordance with a first aspect of the present invention there is provided an apparatus for non-orthogonal monitoring of a variable measurand in a system or process, comprising:

means defining at least three sources having limited spectral widths and non-orthogonal spectral outputs;

a modulator means which is adapted to modulate the outputs of said sources in response to said variable measurand;

at least three detectors which have non-orthogonal responsivities in the measurement domain and which receive the modulated outputs of said sources; and

a processor which converts the detector outputs algorithmically into primary chromatic parameters.

Advantageously, the apparatus can include one or more drive units controlling said source defining means to provide appropriate source outputs.

In some embodiments said source defining means can comprise three discrete sources.

The three discrete sources can be controlled to be repeatedly sequenced in time so that only a respective one of said sources is activated to yield an output in each of three time intervals.

Each source can be individually controlled so as to be separately activated by a respective measurand.

In other embodiments, the source defining means can comprise a single broad spectral width source, the colour temperature of which is controlled via sequential switching in time of three different power supply levels so as to provide said three effectively different sources having non-orthogonal spectral outputs.

The outputs from the detectors are processed to yield chromatic parameters appropriate to the particular application.

In some cases it can be advantageous to effect a second generation/stage processing on the primary chromatic outputs to yield secondary chromatic processing information.

The second generator/stage processing preferably comprises chromatic processing of the primary chromatic parameters in a second different domain, such as time, to yield a further set of chromatic parameters.

It is another object of the present invention to achieve an N>3 system in a manner which overcomes such practical difficulties.

In accordance with a second aspect of the present invention, this is achieved by the use of groups of x non-orthogonal detectors and N−x non-orthogonal sources, said detectors and/or said sources or their operating characteristics being sequentially switched.

This is possible because of the reciprocal nature with respect to detector and source of the sensor output expression (e.g. for optical signals):

V_{OUTN}=·S_{y}(λ)Dₓ(λ)dλ
where λ=wavelength
Dₓ(λ)=wavelength dependent responsivity of the detector x
S_{y}(λ)=spectral output of the source y
N=x+y

In some embodiments, the sources can be discrete, for example comprising separate light sources having different wavelength characteristics. In this case, the separate light sources could be differently coloured LEDs, eg. red, green and blue LEDs.

In other embodiments, the N-x sources can be achieved by means of a single physical element which is driven under different conditions so as to produce correspondingly different wavelength characteristics. For example, the several light sources can be achieved by a single tungsten lamp which is sequentially driven at different supply voltages so as to produce different wavelength characteristics (e.g. by a change in the colour temperature of the lamp), the combined effect of which is equivalent to a plurality of non-orthogonal sources.

The invention is described further hereinafter, by way of example only, with reference to the accompanying drawings, in which:—

FIG. 1 illustrates the overlapping of three detector outputs in a non-orthogonal monitoring system;

FIG. 2 shows an example of signal reduction using N Gaussian processors, for N=2, 3, 6 and 16;

FIG. 3 shows a cylindrical polar space diagram;

FIG. 4a shows how signals of Gaussian form are defined unambiguously by H, L and S;

FIG. 4b shows how non-Gaussian signals are defined as the Gaussian family to which they belong;

FIG. 4c shows how the use of N=4 processors takes into account the degree of skewness;

FIG. 4d shows how the use of N=5 processors takes into account the degree of Kurtosis;

FIG. 5 shows an example of signal reproduction using N Gaussian processors;

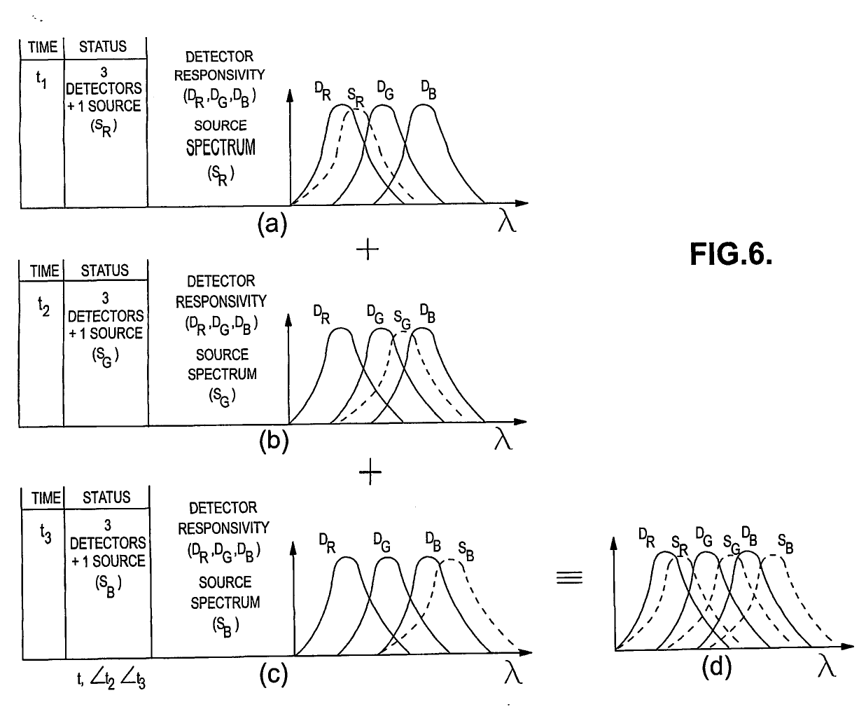

FIG. 6 illustrates the basis of an N=6 detector/source hybrid (3 detectors, 3 sources sequentially switched);

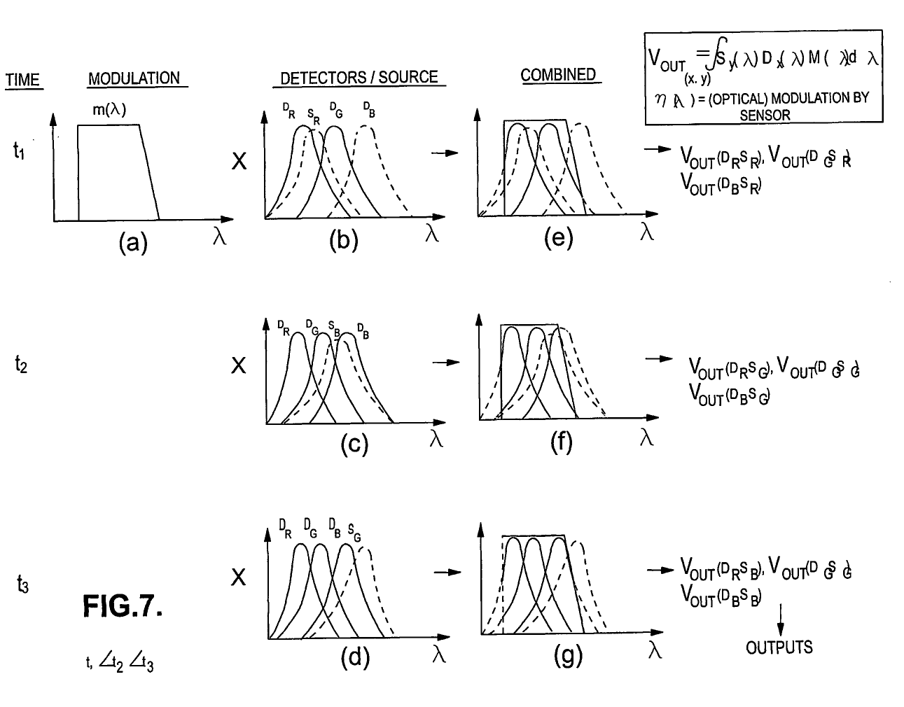

FIG. 7 illustrates the basis of an N=6 detector/source system, having modulation;

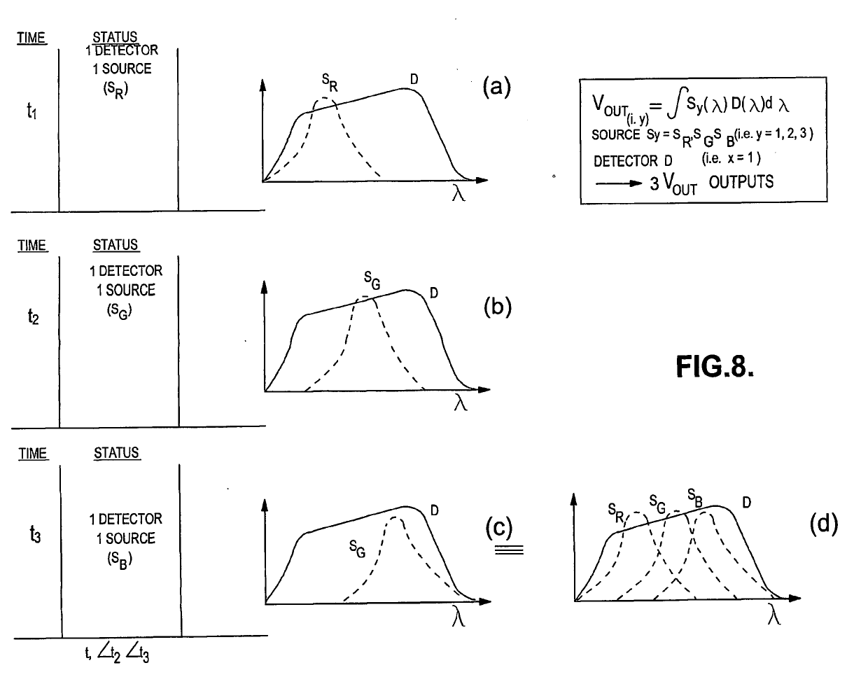

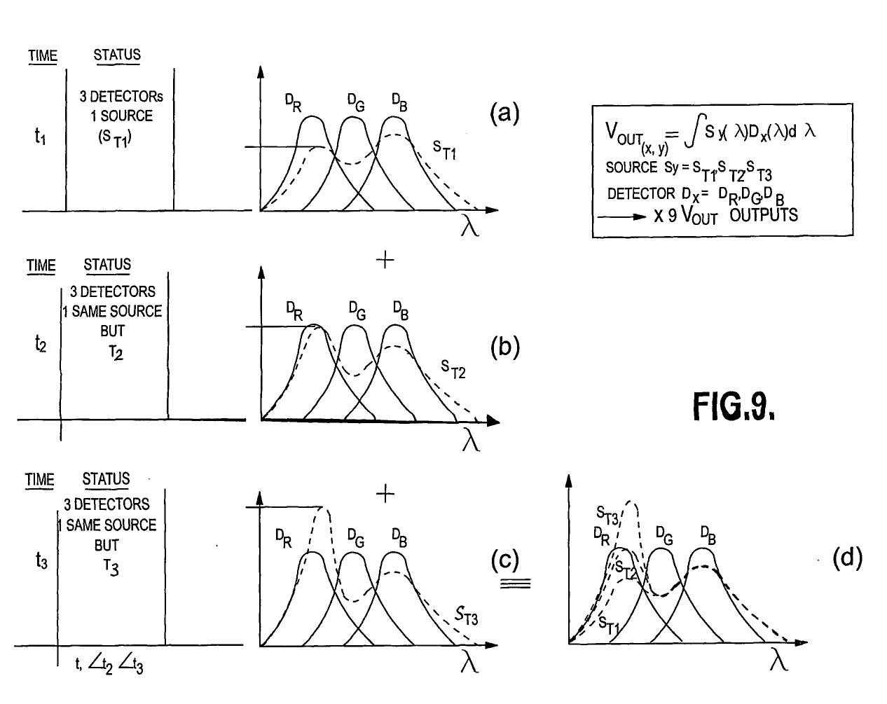

FIG. 8 illustrates the basis of an N=3 non-orthogonal system with the source and detector non-orthogonally inverted;

FIG. 9 illustrates the basis of an N=6 non-orthogonal system having a switched broadband source;

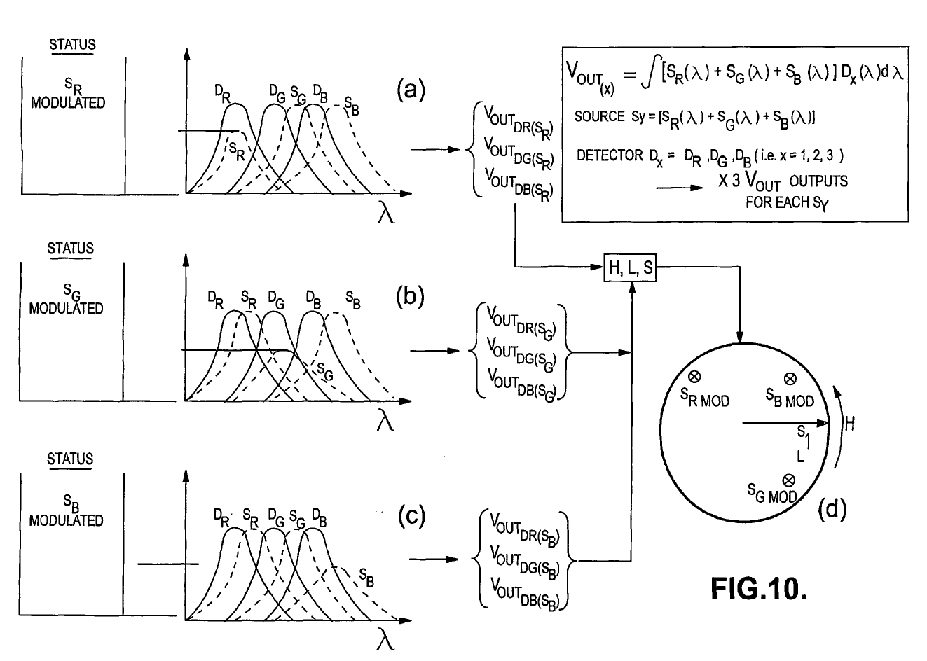

FIG. 10 illustrates the basis of N=6 non-orthogonal system having three detectors and 3 sources with each source voltage being modulated separately in parallel;

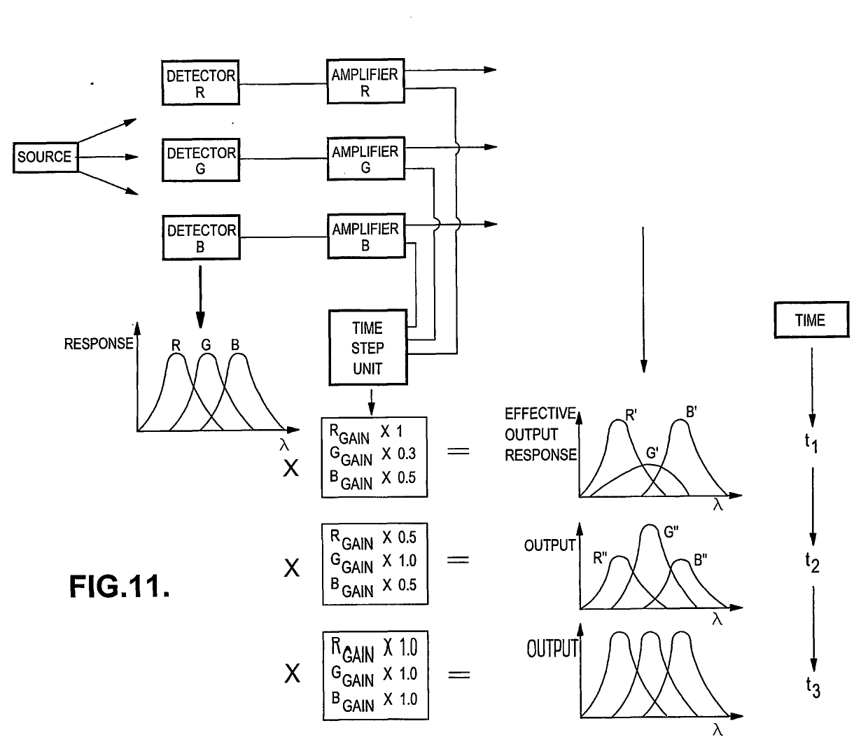

FIG. 11 illustrates the basis of an N>3 detector-source hybrid with variable gain amplifiers;

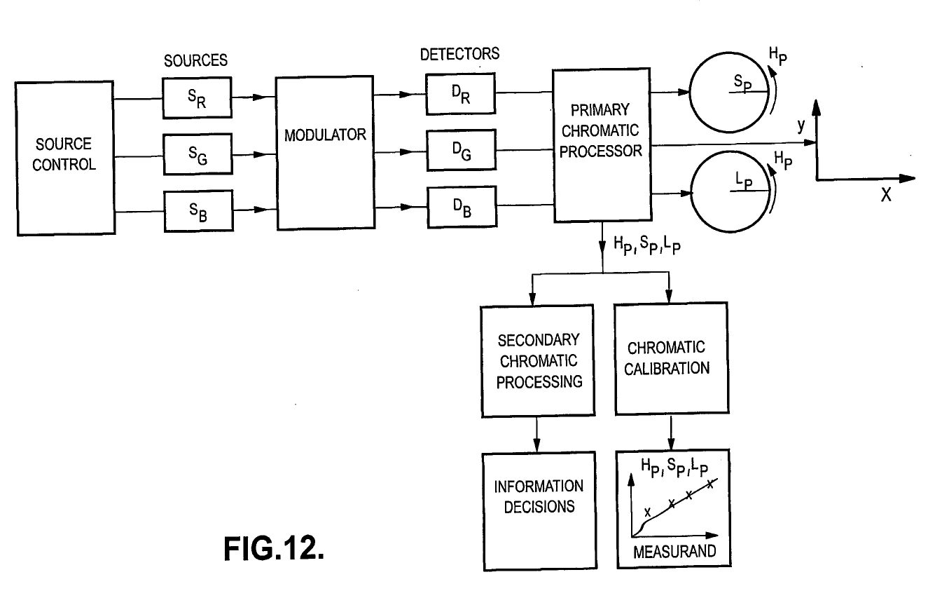

FIG. 12 illustrates the general structure of N=6 chromatic systems, with the possibility of second generation options;

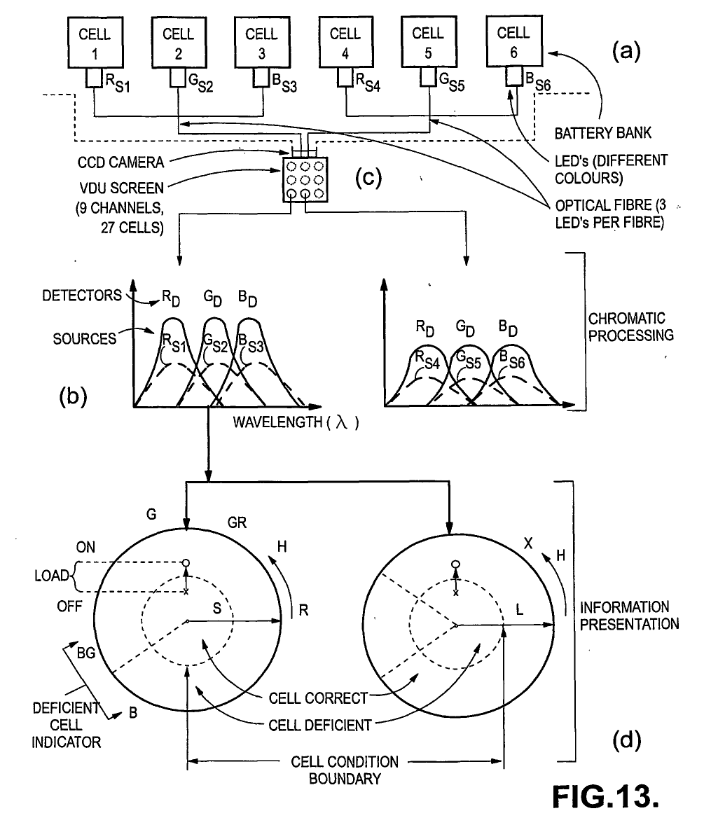

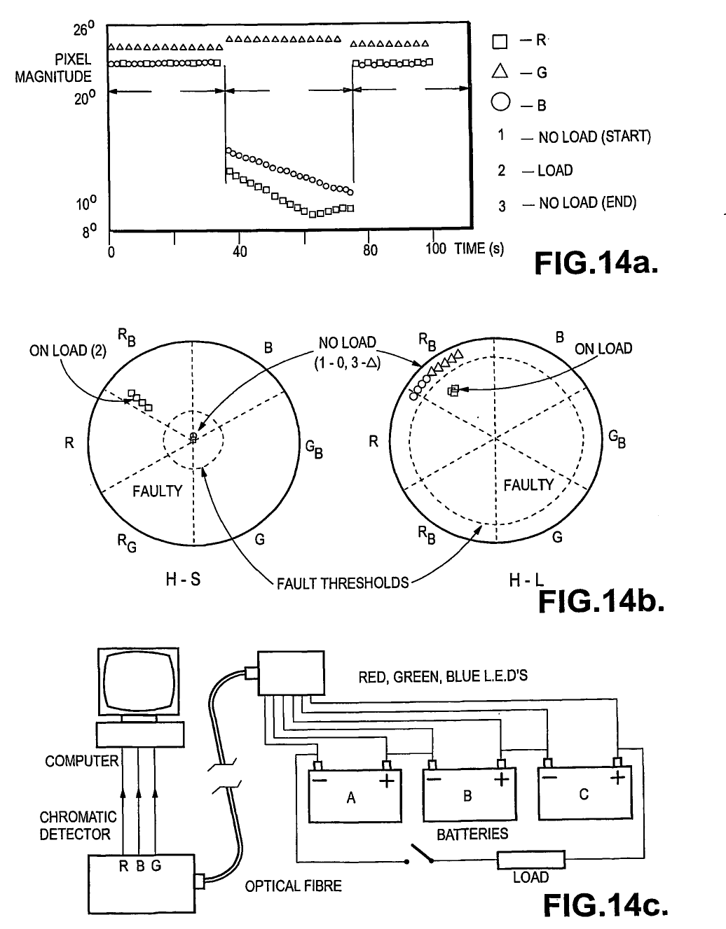

FIGS. 13 and 14 illustrate the application of chromatic processing to the monitoring of a plurality of battery cells;

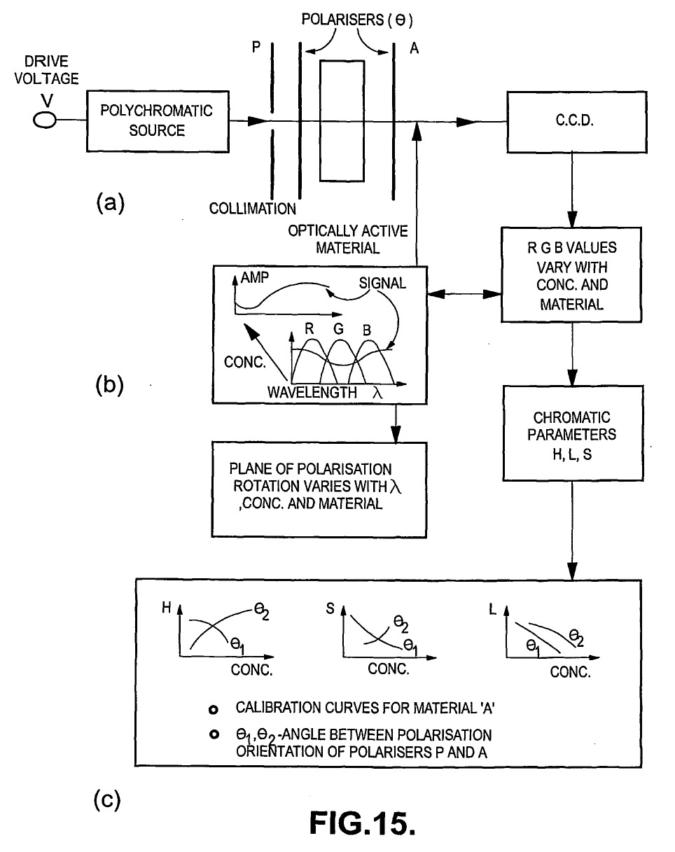

FIGS. 15a-c illustrate chromatic monitoring of polychromatic light propagating through optically active materials;

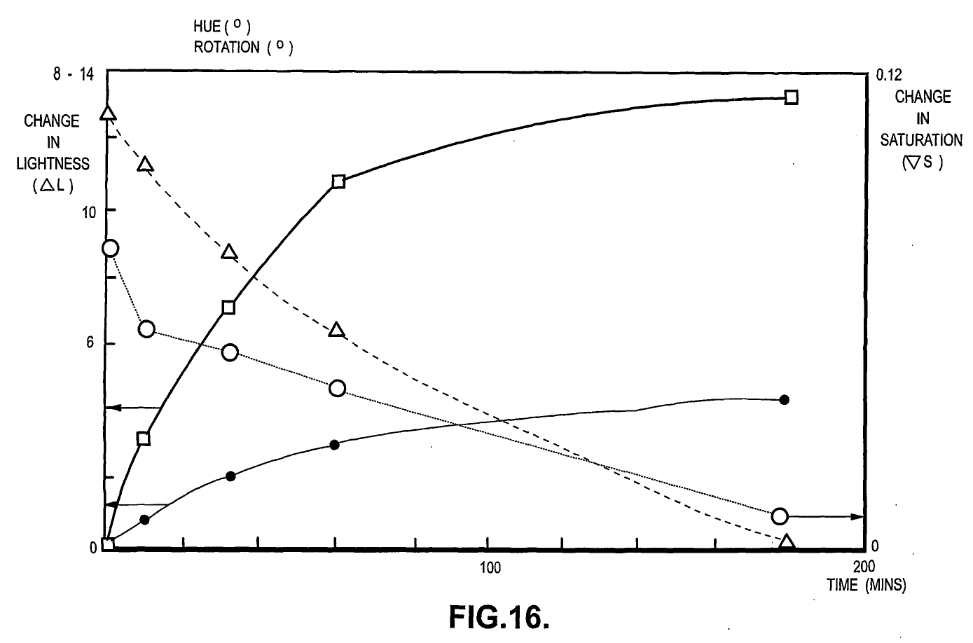

FIG. 16 illustrates the chromatic changes in the concentration of an active component (∝-D-Glucose) with time compared with conventional rotation measurement;

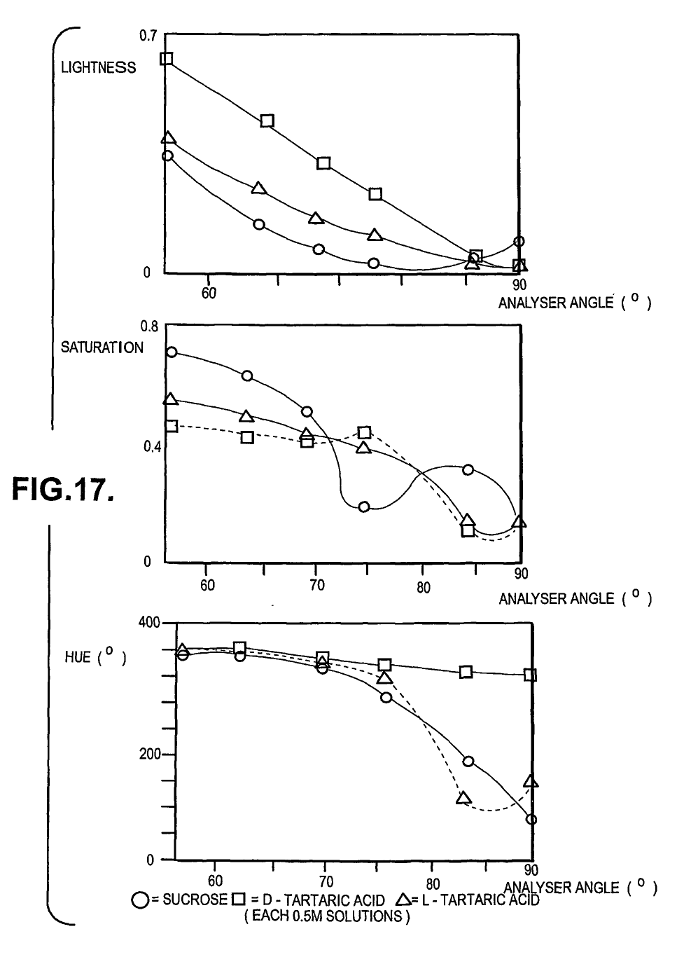

FIG. 17 illustrates chromatic parameters (H,S,L) calibrated against analyser angle for sucrose and tartaric acid (tungsten halogen source);

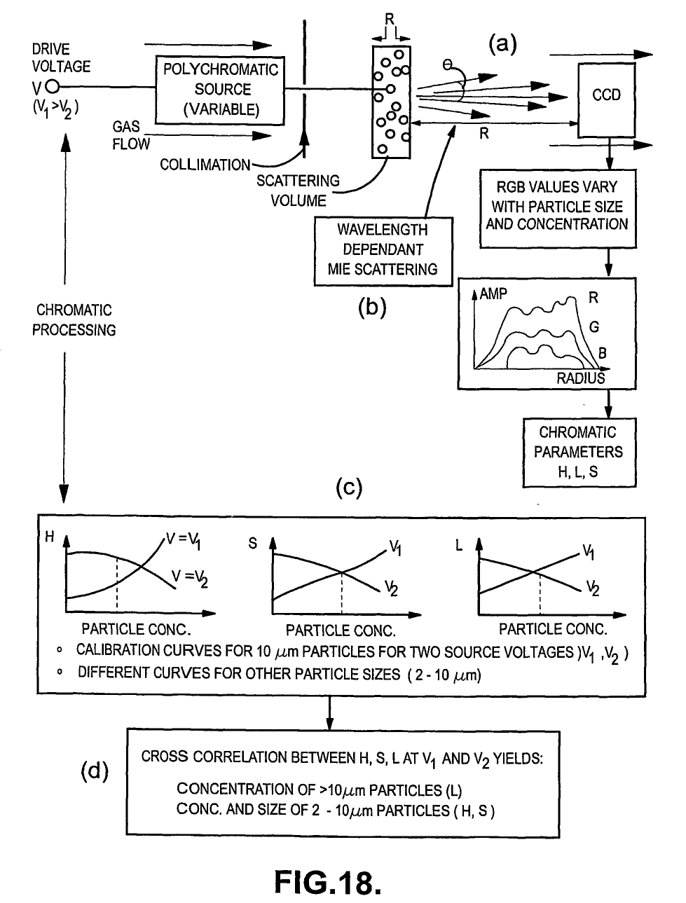

FIG. 18 illustrates the chromatic monitoring of polychromatic light scattered by 2-10 μm sized particles;

FIG. 19 illustrates the effects of particle size and concentration on the chromaticity of scattered polychromatic light;

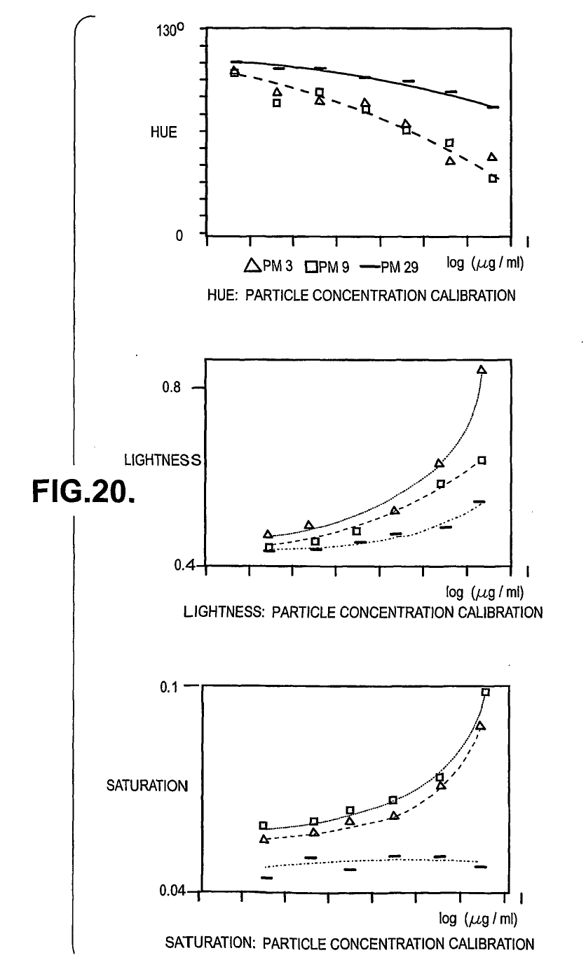

FIG. 20 illustrates an example of chromatic modulation calibration for particulates light scattering (water suspended particulates);

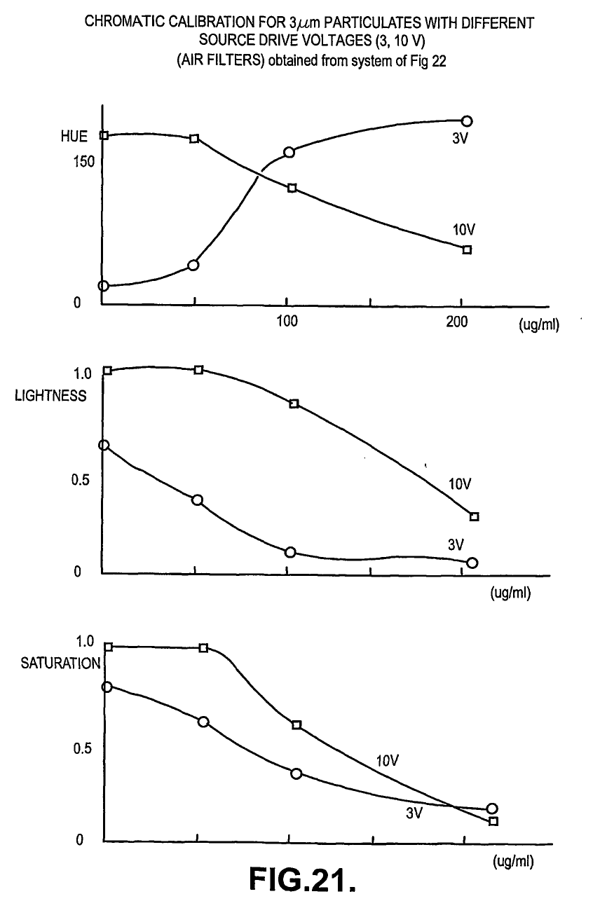

FIG. 21 illustrates chromatic calibration for 3 μm particulates with different source drive voltages (3, 10 v) (air filters);

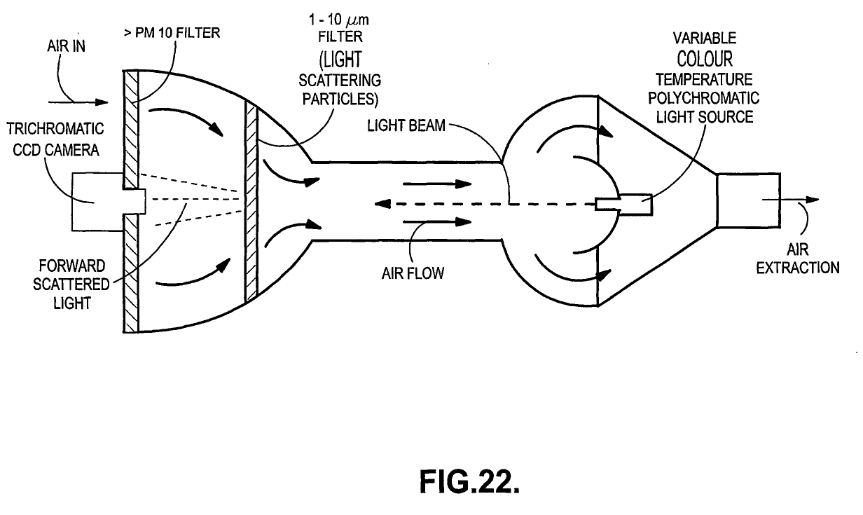

FIG. 22 is a diagrammatic sectional view of one embodiment of an apparatus for a chromatic particulates monitoring system;

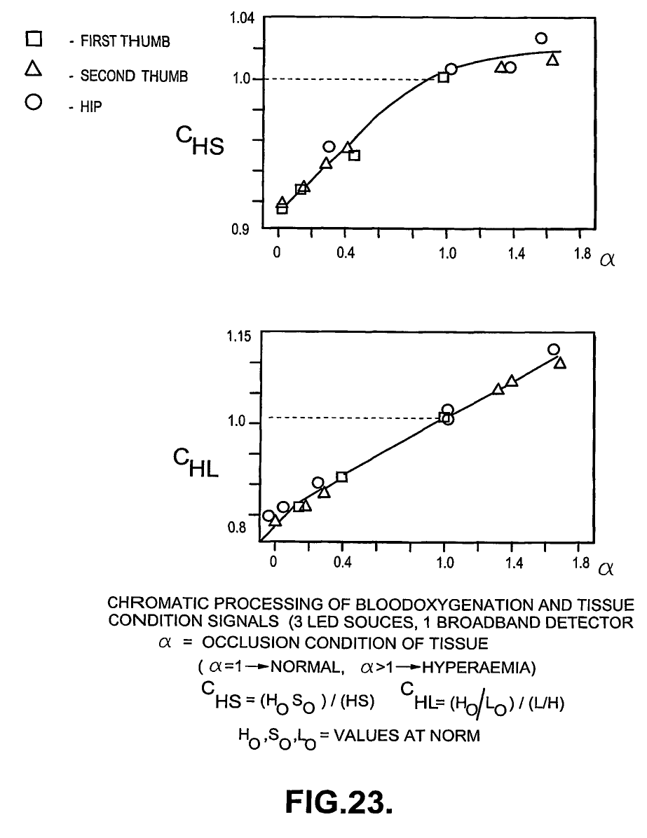

FIG. 23 illustrates an example of chromatic monitoring of combined scattering and absorption using 3 LED sources and 1 spectrometer, with chromatic processing; and

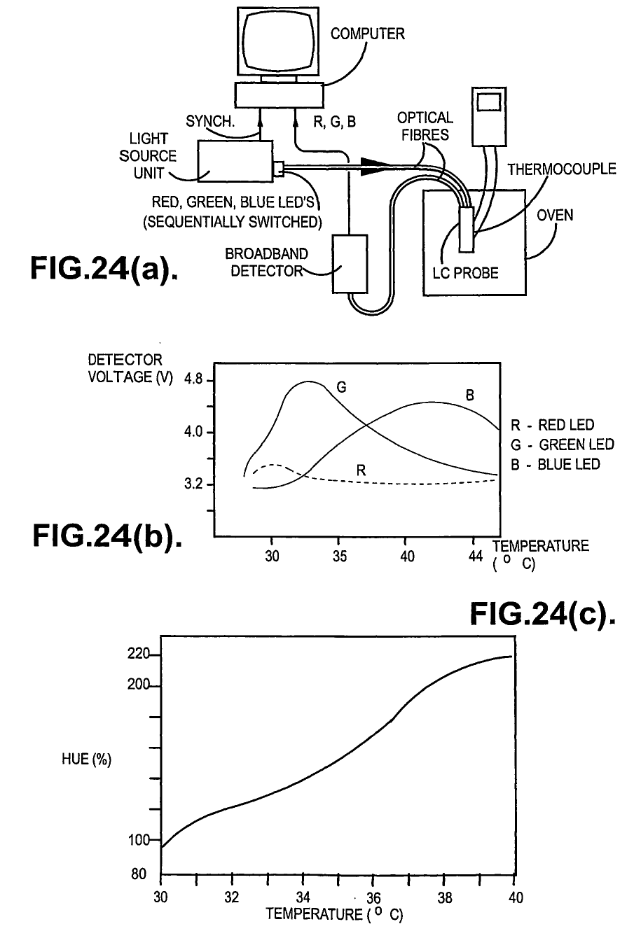

FIGS. 24a-c illustrate a chromatically addressed thermochromic liquid crystal for temperature sensing.

Descriptions are now given in respect of several different techniques for achieving N>3 systems using sequential switching of the sources and/or detectors or of their operating characteristics. Practical examples of the implementations of these various techniques follow.

1. Three Detectors, Three Sources—Sequentially Switched.

Reference is directed to FIGS. 6a-6d which illustrate the operation of a system using three non-orthogonal detectors (D_{R},D_{G},D_{B}) with responsivities which overlap as shown in FIG. 6a, and three medium band sources (S_{R},S_{G},S_{B}) (such as LEDs) having overlapping spectral outputs as shown in FIGS. 6a, 6b, 6c. Each of the sources is arranged to be switched on/off sequentially, for example:

at time t₁, S_{R} is ON (S_{G}, S_{B} are OFF)

at time t₂, S_{G} is ON (S_{R}, S_{B} are OFF)

at time t₃, S_{B} is ON (S_{R}, S_{G} are OFF)

Thus, for each time interval t, there are outputs from each of the detectors (D_{R},D_{G},D_{B}), ie three outputs (constituting a tristimulus process as defined hereinbefore.

Hence for all three time intervals there will be 3×3=9 outputs. The system is therefore effectively an N=6 non-orthogonal processing system (FIG. 6d) having an output Vₒᵤₜ given by:

Vₒᵤₜ(x,y)=·S_{y}(λ)Dₓ(λ)dλ

SOURCE Sy=S_{R}, S_{G}, S_{B} (i.e. y=1, 2 or 3)

DETECTOR Dₓ=D_{R}, D_{G}, D_{B} (i.e. x=1, 2 or 3)
→×9 Vₒᵤₜ OUTPUTS

2. Three Detectors, Three Sources (Sequenced) Plus Modulator

Reference is directed to FIGS. 7a-7g which illustrate the operation of a system using three non-orthogonal detectors D_{R}, D_{G}, B_{B} with responsivities which overlap as shown in FIG. 7b, and three sources having overlapping spectral output S_{R}, S_{G}, S_{B} as shown in FIGS. 7b, 7c, 7d together with an optically modulated signal M(λ) superimposed. The system is therefore like that of FIG. 6 but with modulation.

The spectral transmittance/reflectance etc of the modulator is for example, as shown in FIG. 7a. The modulated signal interacts with the detectors D_{R}, D_{G}, B_{B} after optical activation from each of the three sources (S_{R}, S_{G}, S_{B}) in sequence, t₁, t₂, t₃ (FIGS. 7b, c, d). The output of each detector Vₒᵤₜ₍ₓ₎ is the superposition of the detector responsivity (Dₓ)), the source (S_{y}) and the modulator M(λ) and is defined by 3×3=9 detector outputs.

3. Inverted Source—Detector Tristimulus System

Reference is directed to FIGS. 8a-8d which illustrate the operation of a system using a single broad band responsive detector D (FIG. 8a) and three medium band sources (S_{R}, S_{G}, S_{B}) having overlapping spectral outputs (FIGS. 8a, b, c).

Each of the sources is switched sequentially at times t₁, t₂, t₃. For each time interval t, there is an output from the single detector D i.e. in total 3 outputs corresponding to each of the switched light sources S_{R}, S_{G}, S_{B}.

This constitutes an N=3 non-orthogonal system with the source and detector non-orthogonality inverted (FIG. 8d).

4. Three Detectors, One Broadband Source, Variable Colour Temperature

Reference is directed to FIGS. 9a-9d which illustrate the operation of a system using three non-orthogonal detectors (D_{R}, D_{G}, D_{B}) (FIG. 9a), one broadband source (ST) (FIG. 9a) e.g. tungsten-halogen source which is variable to provide three colour temperatures.

The spectral output of the broad band source may be varied by changing:

(a) the drive current of the source (colour temperature change);

(b) the voltage across the source (colour temperature change); or

(c) the optical filter in front of the source (FIGS. 9a, b, c).

The broad band source output is changed by one or other of the above means sequentially for sufficient time duration t₁, t₂, t₃ (FIGS. 9a, b, c). Thus all three detectors D_{R}, D_{G}, D_{B} are addressed by effectively three different sources spectra (FIGS. 9a, b, c) albeit sequentially from the same source. During each of the three time intervals following t₁, t₂, t₃ there will be three detection outputs, one from each of the detectors D_{R}, D_{G}, D_{B}, so constituting a subsidiary tristimulus process.

Hence for all three time intervals commencing at t₁, t₂, t₃ there will be a total of 3×3=9 outputs and the system is effectively an N=6 non-orthogonal processing system (FIG. 9d).

It should be noted at this juncture that it is not essential for all N chromatic processors (detectors, sources) to be all mutually non-orthogonal; it is sufficient for only some components to be non-orthogonal.

In the FIG. 9 manifestation, all three detectors are non-orthogonal with respect to each other and the three conditions of the light source. The non-orthogonality of the three states of the light source with each other is less obvious but does not affect the need for the system itself to be non-orthogonal.

5. Three Detectors, Three Sources with Each Source Also Being a Modulator

Reference is directed to FIGS. 10a-10d which illustrate the operation of a system using three non-orthogonal detectors (D_{R}, D_{G}, D_{B}) (FIG. 10a), three medium band sources (S_{R}, S_{G}, S_{B}) with overlapping spectra (FIG. 10a).

Each source has its output modulated by a measurand, e.g. each source is connected to a different drive circuit e.g. battery output of each source controlled by the battery drive circuit. Thus instead of the sources being switched sequentially in time (t₁, t₂, t₃ etc) (as an example 1 of N=6, 3 detectors, 3 sources), the sources are monitored in parallel and the output of each varies in synchronisation with the condition of the particular drive circuit (battery) to which it is connected (FIGS. 10a, b, c).

Hence the relative conditions of each of the three drive circuits (batteries) may be indicated from the outputs of the detectors (D_{R}, D_{G}, D_{B}) which for ease of assimilation of the information may be processed to yield H, L, S and produce H-L, H-S polar maps.

By way of example, FIG. 10d shows an H:L/S polar diagram with the approximated location of each of three points corresponding to FIGS. 10a, b, c as S_{R} modulated, S_{B} modulated, S_{G} modulated. The location of a point depends on the relative magnitudes of (S_{R}, S_{G}, S_{B}).

The condition of each circuit (battery) connected to each source (S_{R}, S_{G}, S_{B}) is indicated by the position of the corresponding point on the H-L, H-S polar diagrams.

An example of the application of this technique for use in battery condition monitoring is described further below, wherein each source voltage is modulated separately in parallel.

6. One Source, Three Detectors and with Variable Gain Amplifiers

Reference is directed to FIG. 11 which illustrates the operation of a system having three detectors and one source hybrid, each of the detectors having variable different gains.

By varying the gains of the amplifiers of each detection channel by different relative amounts, the effective degree of non-orthogonality of the detectors can be changed (FIG. 11). By varying the gains of each amplifier with time in stepwise, cyclic manner (t₁, t₂, t₃ FIG. 11) the effective number of detectors can be increased within certain boundaries. Thus, for a given input optical signal the resulting H, L, S co-ordinates are different. For different input optical signals, the H, L, S co-ordinates for each signal change but by different amounts, so constituting additional chromatic dimensions.

Application Examples of N≦6 Hybrid Detector-Source Systems

The general structure of an N=6 chromatic monitoring system is summarized in FIG. 12, with the possibility of second generation/second stage chromatic processing added.

Three sources S_{R}, S_{G}, S_{B} of limited spectral widths (e.g. Light Emitting Diodes) are controlled via a drive unit to provide appropriate outputs. The sources have non-orthogonal spectral outputs.

The sources may be preferentially controlled to be sequenced in time so that only a single source is activated to yield an output in each of three time intervals t₁, t₂, t₃ (as in FIG. 6a-6d), the sequence being continuously repeatable.

Alternatively, each source may be individually controlled via the control unit to be separately activated by a measurand (as in FIG. 10).

A further manifestation is that the three separate, limited spectral width sources (S_{R}, S_{G}, S_{B}) are replaced by a single broad spectral width source (e.g. tungsten halogen lamp) the colour temperature of which is controlled by the voltage/current for the source control via sequential switching in time t₁, t₂, t₃ (as in FIG. 9).

The outputs from the monitoring system are received by three detectors/processors (D_{R}, D_{G}, D_{B}) (FIG. 12) having non-orthogonal responsivities in the measurement domain.

In addition the gains of each detector channel RGB may be separately time stepped (as in FIG. 11).

The detectors may be in the form of three single detectors or alternatively may consist of clusters of three non-orthogonal detectors which may additionally provide spatial discrimination.

The outputs from the detectors are processed to yield chromatic parameters appropriate to the particular application. The processing may yield Hₚ, Sₚ, Lₚ parameters (Hue, Saturation, Lightness), x:y parameters or other form of chromatic parameters.

A second generation/stage chromatic processing may be performed on the primary chromatic outputs (Hₚ, Sₚ, Lₚ) to yield secondary chromatic processing, as described further hereinafter. The measurand which is the key to the monitoring, is addressed via the modulator (FIG. 12) which converts the measurand into a form for providing chromatic modulation (e.g. in the case of broad spectral systems, a modification of the spectral signature in correspondence to the magnitude of the measurand). The modulation is acted upon the outputs of the sources (S_{R}, S_{G}, S_{B}) and detected by the detectors (D_{R}, D_{G}, D_{B}). Several different types of chromatic modulators may be assembled for accessing various measurands.

By way of examples only, referring to optical modulation domain as only one of several domains (e.g. acoustical, mass etc), the following are typically available chromatic modulation means:
1. The modulator may take the form of thermo chromatic element whose spectral transmission or reflection varies as a function of temperature, so providing transduction from temperature to spectral change. The technique also applies to liquids which change colour with temperature (e.g. CoCl₃ solutions) and solids likewise (e.g. GaAs in the infra red).
2. The modulator may take the form of a cell containing an optically active chemical with optical polarising filters at predetermined inclination to each other whereby different optical wavelengths have their planes of polarisation rotated by differing amounts, each of which depends upon the chemical type and concentration so that the spectral signature and hence chemical co-ordinates are indicative of the concentration and type of active components present.
3. The modulator may be in the form of particulates, which scatter light of different wavelengths preferentially in different angular directions depending upon their size and concentrations (Mie scattering) or alternatively are composed of compounds, which absorb different wavelengths characteristically so affecting the spectral signature (hence chromatic co-ordinates) in defined manners. By way of example, the particulates may be micron sized particles, or organic molecules forming parts of biological tissues such as haemoglobin of different types (oxyhaemoglobin etc) melamine, bilirubin etc).
4. As examples for applicabilities in domains other than optical the following are typical of available chromatic modulation means.
(a) The use of N acoustic receivers deployed in star and/or delta geometric orientation for locating the position of a sound/ultrasonic source within given boundaries as described in a co-pending application filed concurrently with the present application.
(b) The use of N processors for compressing data from mass spectra or an array of different parameter transducers, as described in a further co-pending application filed concurrently with the present application.

There now follows a discussion of the second generation/stage chromatic processing referred to hereinabove.

Second Generation Chromatic Processing

Conventional chromatic monitoring involves tracking signals with 2<N<3 sensors or processors. The sensors/processers have usually applied to the optical domain whereby the measurand was wavelength dependent intensity. The procedure was to address the signal via N=3 processors (R, G, B) which overlap (non-orthogonal) in the wavelength domain to yield signal defining chromatic parameters H, L, S or x, y etc.

Currently, the approach has been extended to other measurand domains, which include
Acoustic frequency (af)
Radio frequency (rf)
Atomic mass (am)
Spatial location (sl)
Combination of different parameters (e.g. temperature, pressure, volume; gas types etc) (sn).

Possibilities of additional deployment have also been highlighted, which are described herein, namely:—
3≦N≦6 PROCESSORS.
Non Gaussian processors.
Source rather than detector based chromatic systems.

In addition to differences occurring in these new applications, a major development of the present proposals lies in sequential chromatic processing. This involves conventional chromatic processing of a series of snap shots of measurand (ar, rf, am, sl, sn etc) to yield values of measurand based chromatic parameters (HₚLₚSₚ) each of which is subsequently processed chromatically in a second different domain e.g. time (t), to yield for example chromatic parameters (Hₜ(Hₚ), Lₜ(Hₚ), Sₜ(Hₚ); Hₜ(Sₚ), Lₜ(Sₚ), Sₜ(Sₚ); Hₜ(Lₚ), Lₜ(Lₚ), Sₜ(Lₚ)).

Physical meanings can be ascribed to each of these second generation chromatic parameters and they may be used to quantify the performance, event occurrence (e.g failure) etc of a system taking account of the context of the system (e.g. time variation). To assist in the understanding of the methodology specific examples are now described.

### Prognosis of System Degradation

e.g. mass spectrometric gas analysis to yield gas species indicators.

### Primary Chromatic Processing

Each measurand component (e.g. gas species) is ordered according to the prognostic information needed (e.g. indicators of system failure in order—gas A, B, C etc).
Magnitude plotted against each component to form an effective “magnitude: component spectrum”.
The magnitude: component spectrum is addressed by three overlapping (non-orthogonal) filters.
The filter outputs (R_{P}, G_{P}, B_{P}) are converted by an appropriate algorithm into chromatic parameters (e.g. H_{P}, L_{P}, S_{P}) which can be displayed on H-L and H-S chromatic maps.
The meaning of H_{P}, L_{P}, S_{P} is as follows

Hp—dominant components

Lp—effective magnitude of total components

Sp—nominal spread of components present
For system prognosis, if Hₚ→gas A (most significantly gas indicative of system event e.g. failure) Lₚ is high and Sₚ→1 then there is a high probability of system failure ensuing; if Hₚ→gas A, Lₚ is moderate and Sₚ→0 the probability of failure is low but finite.
The probability of the outcome concerned (e.g. failure)_may therefore be expressed in terms of H_{P}, L_{P}, S_{P} ie.

Pp=P(H_{P},L_{P},S_{P})=P(H_{P})P(L_{P})P(S_{P})

Where P(H_{P}) P(L_{P}) P(S_{P}) represent the outcome probability indicated by each chromatic parameter H_{P}, L_{P}, S_{P}, e.g.

(X_{P})=Xₒexp[−½(X−Xₘ)/σₓ]²

### Second Generation Chromatic Processing

the primary chromatic processing is based upon a “snapshot” of R_{P}, G_{P}, B_{P} and ignores the “context” of the system e.g. for the gas specy example the system history/trend with time is ignored.
However the contextual information may contain important prognosis information, which can be observed by mapping the primary chromatic snapshots at different context conditions (e.g. different times) on Hp-Lp, Hp-Sp maps.
Often the complex nature of such mapping does not facilitate the recognition nor qualification of trends.
Therefore a second generation chromatic processing may be utilised to quantify such contextual information (e.g. system history).
In the second generation chromatic processing each of the primary chromatic parameters H_{P}, L_{P}, S_{P} is determined for each different contextual value (e.g. each time).
Three secondary spectra are then formed corresponding to Hp:t; Lp;t, Sp;t where t represents the context value (e.g. instant in time) into three secondary chromatic parameters i.e. Hₜ(Hₚ), Lₜ(Hₚ), Sₜ(Hₚ); Hₜ(Lₚ), Lₜ(Lₚ), Sₜ(Lₚ); Hₜ(Sₚ), Lₜ(Sₚ), Sₜ(Lₚ).
Each of the three secondary spectra is addressed by three non-orthogonal filters (RₜGₜBₜ) which convert each primary chromatic parameter (Hₚ, Lₚ, Sₚ) into three secondary parameters i.e. Hₜ(Hₚ), Lₜ(Hₚ), Sₜ(Hₚ); Hₜ(Lₚ), Lₜ(Lₚ), Sₜ(Lₚ); Hₜ(Sₚ), Lₜ(Sₚ) Sₜ(Sₚ).
This produces a total of nine secondary parameters, which represents a quantification of context trend (e.g. time variation).
The probability of an event is then given by

Pp,t=P(Hₜ(Hₚ))P(Lₜ(Hₚ))P(Sₜ(Hₚ))P(Hₜ(Lₚ))P(Lₜ(Lₚ))P(Sₜ(Lₚ)P(Hₜ(Sₚ))P(Lₜ(Sₚ))SP(Sₜ(Sₚ)).
By way of example, for the time varying gas analysis the secondary chromatic parameters have the following meaning:

Lₜ(Lₚ)=Total amount of gas produced in time t.

Lₜ(Hₚ)=Dominant time at which most gas was produced.

Lₜ(Sₚ)=Effective spread of time over which gases produced.

Hₜ(Lₚ)=Time extent for which there is a dominant gas.

Hₜ(Hₚ)=Dominant time at which the most dominant gas occurs.

Hₜ(Sₚ)=Time spread of dominant gases.

Sₜ(Lₚ)=Measure of time extent of gas spreading.

Sₜ(Hₚ)=Dominant time at which the largest spread occurs.

Sₜ(Sₚ)=Time spread of gas spread.

### Chromatic Battery Cell Monitoring

Each of the three batteries activates a different coloured LED the intensity of which is governed by the battery condition via the current it can supply. The outputs from all three LEDs are fed through a single fibre link and the condition of each battery determined from the chromaticity of the output signal.

The PRIMARY CHROMATIC MONITORING utilises the LEDs output (Rₚ Gₚ Bₚ) to yield the primary chromatic parameters (Hₚ, Lₚ, Sₚ) from which each battery condition is determined.

The SECONDARY CHROMATIC PROCESSING tracks the time variation of (Hₚ, Lₚ, Sₚ) to yield second generation chromatic parameters of the PROGNOSIS OF SYSTEM DEGRADATION Hₜ(Hₚ), Lₜ(Hₚ), Sₜ(Hₚ); Hₜ(Lₚ), Lₜ(Lₚ), Sₜ(Sₚ); Hₜ(Sₚ), Lₜ(Sₚ), Sₜ(Sₚ).

Particulates from Polychromatic Light Scattering
Changes are produced in the chromaticity of polyromatic light scattered by 2-10 μm particles, which depends upon the particle size and concentration.
PRIMARY CHROMATIC PROCESSING of the outputs from three chromatic detectors (Rₚ, Lₚ, Sₚ) yields the chromatic parameters (Hₚ, Lₚ, Sₚ). Particle size and concentration are determined via calibration from Hₚ, Lₚ, Sₚ.
SECONDARY CHROMATIC PROCESSING enables this variation of particulates sizes and concentration to be determined using the methodology of section 2 of “PROGNOSIS OF SYSTEM DEGRADATION”.

### Monitoring Chemical Reactions of Optically Active Materials

Changes are produced in the chromaticity of polarised polychromatic light whose planes of polarisation at different wavelengths are rotated by different amounts by the chemical changes in the optically active chemical mixture.
The PRIMARY CHROMATIC PROCESSING of the outputs from three chromatic detectors (Rₚ, Gₚ, Bₚ) yields chromatic parameters (Hₚ, Lₚ, Sₚ) whose values vary with the composition and concentration of the two optically active chemicals.
SECONDARY CHROMATIC PROCESSING enables time variation of the composition and concentration to be determined using the methodology of section 2 “PROGNOSIS OF SYSTEM DEGRADATION”.

Tissue Pigmentation Monitoring
Another example of second generation processing is in the tracking of tissue pigmentation variation caused by changes in blood oxygenation and background melanin changes.
The use of primary chromatic parameters (Hₚ, Lₚ, Sₚ) individually as variables depending upon blood concentration and degree of oxygenation leads to non-motonic and range restricted relationships.
However by combining the primary chromatic parameters via appropriate algorithms, unique monotonic functions of blood oxygenation etc are obtained.
By way of example, second generation chromatic parameters are derived to yield a monotonic variation with various tissue parameters. these are

For Tissue Oxygenation

$${C}_{HS} = \frac{{H}_{o}}{H} \times \frac{{S}_{o}}{S}$$

For Blood Content of the Tissue

$${C}_{HL} = \frac{{H}_{o}}{H} \times \frac{L}{{L}_{0}}$$

These parameters may be further processed to track and quantify time variation as indicated in section 2 of “PROGNOSIS OF SYSTEM DEGRADATION”.

Further specific examples are now described which illustrate the application of the principles discussed hereinbefore to practical monitoring systems.

There now follows a description of chromatic processing of a 3≦N≦≦6 system applied to the monitoring of a plurality of battery cells.

Referring to FIG. 13a, a battery bank composed of M cells is divided into a (M/3) trio of cells, each member of which drives a Light Emitting Diode (LED) FIG. 13a) emitting a spectrum which is non-orthogonal in relation to the spectra of the other two LEDs of the trio (FIG. 13b), ie. they exhibit non-orthogonal emission in the wavelength domain. The outputs from the LEDs forming each trio are transmitted via a single optical fibre 50 to a 3 element (R_{D}, G_{D}, B_{D}) chromatic detector (FIG. 13b), ie. three detectors with non-orthogonal responses in the wavelength domain. The outputs from the (M/3) trio of cells are detected by a cluster of chromatic detectors which may be in the form of a charge coupled device (CCD) camera (FIG. 13c).

The output from each chromatic detector (R_{D}, G_{D}, B_{D}) is processed to yield H.S.L, values which can be displayed on H-L, H-S polar diagrams (FIG. 13d). Thus the chromatic co-ordinates for each trio of cells are determined by the voltages provided by the three batteries driving the three LEDs. Consequently the chromatic co-ordinates of a trio LED are indicative of the conditions of the battery cells connected to the LEDs.

One embodiment of an apparatus for calibrating such a system is shown in FIG. 14c, being an example of a 3 LED, 3 detector system. Also shown are the R.G.B outputs with the battery on load (FIG. 14a) and the corresponding H-S, H-L polar diagrams (FIG. 14b).

A deficient cell is manifest by an abnormal reduction in the voltage across the cell under load conditions (FIG. 14a) which consequently affects the location of the monitored chromatic signal on the H-L, H-S polar diagrams (FIG. 13d, FIG. 14b).

Threshold boundaries between correct and deficient cell behaviours may be established empirically on the H-L, H-S polar diagrams (FIG. 12d, FIG. 14b). The location of the operating point of a trio of cells on the H-L, H-S diagrams also indicates which of the three cells are deficient and to what degree.

Thus, the presence of a deficient cell within the three-battery group may be detected and identified by a change in the Hue and/or Saturation in the output of the tristimulus detector. The presence of three deficient cells is indicated by changes in lightness more than hue and saturation. Discrimination can be improved by comparing on and off load battery signals.

The system provides an economic monitoring means by reducing the number of optical fibre links from the battery cells by ⅓, by providing inherent electrical insulation, by utilising an economic opto electronic scanning means via the CCD camera and by providing an easily assimilable display in the form of H-L and H-S maps.

There now follows a description of chromatic processing applied to the monitoring of optically active materials which rotate the plane of polarisation of linearly polarised light.

Referring to FIG. 15a, polarised polychromatic light is passed through optically active materials before emerging through an analysing polarising filter inclined at an angle to the input plane of polarisation and then to chromatic detectors (D_{R}, D_{G}, D_{B}). The spectral signature of the detected polychromatic light is determined by both the concentration, FIG. 16 and type of chemical components of the optically active species, FIG. 17. The angle through which the plane of polarisation of light passing through an optically active material is rotated is given by

∂α=[α]_{λ}^{T}c.l

### Where [α]_{λ}^{T}

is the specific rotation (being dependent on material, temperature, optical wavelength), c is the concentration (mass of optically active component per unit volume of solute), 1 is the path length. According to a simplified form of the Drude equation, the wavelength dependence of the specific rotation is given by

[α]_{λ}^{T}c.l≈A/(λ²−λ_{c}²)

Where A is a constant characteristic of the molecular species and λ_{c} is a factor determined by the dominating process causing optical activity. These various wavelength components of the polychromatic light are affected differently so changing the spectrum of the light.

The spectral signature may be characterised by the chromatic co-ordinates determined for the spectrum with appropriate chromatic detectors/processors (D_{R}, D_{G}, D_{B}) which yield outputs R,G,B from which H,L.S are determined (FIG. 15b). The concentration of each of two optically active species is determined by calibration in terms of the chromatic co-ordinates H.S.L. (FIG. 15c).

There now follows a description of chromatic processing applied to monitoring of polychromatic light scattered by small particles, for example in the 2-10 μm range.

Reference is directed in this connection to FIG. 18 wherein polychromatic light is passed through the light scattering/absorbing medium before detection by an array of chromatic detectors (D_{R}, D_{G}, D_{B}) (FIG. 18a) from which the chromatic co-ordinates (H,S,L) of the received light are determined (FIG. 18b).

The spectral signature of the polychromatic light scattered by micro particles is governed by Mie theory and depends upon the concentration (N) and size (a) of the scattering particles, the optical wavelength (λ) (FIG. 19) as well as the path length (ι) and scattering angle (θ) (FIG. 18a) i.e.

I=Iₒf(N,a,λ,α,θ,R)

(I, I₀ are the intensities before and after scattering, α is the polarisability of the scattering particles, R is the separation of the detector from the scattering event). For the special case of Rayleigh Scattering (α<< [symbol] ₁₀):

I=Iₒ8II⁴Nα²(1+Cos² Θ)(λ⁴a²)⁻¹

The implication is that since different wavelengths (λ) can be preferentially scattered through different angles (Θ), the spectrum of the polychromatic light scattered at different angles varies with particle concentration (N) and size (a), these may be quantified via the chromatic co-ordinates of the light scattered at a given angle.

The transmission of polychromatic light through an optically absorbing medium is governed by the Beer-Lambert Law (e.g. Jones et al (2000)).

I(λ)=Iₒ(λ)exp^{(-Σ}ₕ^{β}ₕ(λ)(cₕl)

Iₒ(λ), I(λ)=Intensity of light of wavelength (λ) before and after transmission through the medium respectively.
βₕ(λ)=Wavelength dependent extinction coefficient of species h
Cₕ=Molar concentration of absorbing species h
I=path length

Since different wavelengths have different extinction coefficients βₕ(λ) the spectrum of the emerging polychromatic light differs from that of the input polychromatic light, which change may be quantified by changes in the chromatic co-ordinates of the incident and emerging light.

In practice either scattering or absorption may dominate or both may be superimposed. By way of example scattering may dominate for 2-10 μm particles suspended in air: scattering and absorption are superimposed for light transmitted though or reflected from biological tissue.

In both scattering and absorption cases the determined chromatic coordinates (H,L,S) (FIG. 8(b)) are related to the physical/chemical condition of the modulating medium via predetermined calibration curves.

By way of a scattering example the concentration of 10 μm light scattering particulates may be determined from calibration curves of H,L,S against 10 μm particles concentration (FIG. 18(c)). Different sized particulates (e.g. 2-10 μm) produce different dependencies on H, L, S and may be distinguished from a cross correlation of each of the values of H, S and L from the different calibration curves so obtained (FIG. 18(d), FIG. 20). Furthermore there is sufficient information contained in the H,S,L co-ordinates to distinguish between mixtures of particulates of different sizes and concentration by interpolation between the H,L,S: c, a calibration curves. A further level of discrimination is provided by varying the drive voltage (V) (FIG. 18(e)) of the polychromatic source (e.g. tungsten halogen lamp) to produce different source colour temperatures, hence source spectra, and calibration curves (FIG. 21). For instance by such means the particulates concentration range, which may be addressed, can be extended.

One example of an apparatus for chromatic monitoring of light scattered from 1-10 μm particles in air is shown in FIG. 22.

By way of a combined scattering and absorption example, blood oxygenation and tissue (melainine) condition may be addressed from values of chromatic co-ordinates (H,L,S) determined from the modulation of polychromatic light and previously obtained calibration curves for blood oxygenation. Both blood oxygenation and melamine variation affect the chromatic signatures. Consequently a processing is adopted for removing the effects of melamine variation. Second generation chromatic parameters determined empirically are:

C_{HS}=(HₒSₒ/(HS)

C_{HL}=(Hₒ/Lₒ)(L/H)

where the suffix zero corresponds to normal blood content of the tissue. C_{HS}, C_{HL} are monotonic functions of blood oxygen content and tissue blood content respectively (FIG. 23). Discrimination can be improved through the use of N>3 with three non-orthogonal LED sources sequentially switched.

FIG. 19 illustrates the effects of particle size and concentration on the chromaticity of scattered polychromatic light.

Referring to this FIG. 19 in general

I=IₒF[N,a,λ,∝,θ,R]

where N=particle concentration a=particle diameter

λ=wavelength of light ∝=polarisability of particles

θ=scattering angle R=distance to detector

e.g. Rayleigh Scattering (α<< [symbol] ₁₀)

I=Iₒ8II⁴Nα²(1+Cos² Θ)(λ⁴a²)⁻¹

Thus, the polychromatic light spectrum is modified according to particle size, particle diameter and scattering angle, and hence the chromatic co-ordinates of the scattered light are a function of N and a at a given θ.

There now follows a description of chromatic processing applied to the monitoring of materials which change colour in response to varying operation parameters of systems, i.e: the sources provide the non-orthogonality rather than the detectors. In this example a modulator is used in the form of a thermo chromatic element whose spectral transmission or reflection varies as a function of temperature so providing transduction from temperature to spectral change (FIG. 24). The technique can be applied equally to liquids which change colour with temperature (e.g. CoCl₃ solutions) and likewise solids (e.g. GaAs in the infra red domain).

FIG. 24a shows an optical fibre sensor calibration system comprising a thermo-chromatic element addressed by an optical fibre via which polychromatic light is transmitted from three LEDs with non-orthogonal outputs in the wavelength domain to address the thermo chromatic elements and the wavelength modulated light returned via the optical fibre to a single broadband detector.

FIG. 24b shows red, green, blue LEDs signals for different temperatures. FIG. 24(c) shows hue/temperature calibration curves (measured). Changes in H, L, S produced by thermo chromatic variations allow temperature to be determined via calibration, the three LED sources being switched sequentially in time to provide discrimination between R, G, B via the single broadband detection (FIG. 24b).

1. Apparatus for non-orthogonal monitoring of a variable measurand in a system or process, comprising:
means defining at least three sources having limited spectral widths and non-orthogonal spectral outputs;
a modulator means which is adapted to modulate the outputs of said sources in response to said variable measurand;
at least three detectors which have non-orthogonal responsivities in the measurement domain and which receive the modulated outputs of said sources; and
a processor which converts the detector outputs algorithmically into primary chromatic parameters.

2. Apparatus as claimed in claim 1, including one or more drive units controlling said source defining means to provide appropriate source outputs.

3. Apparatus as claimed in claim 1, wherein said source defining means comprises three discrete sources.

4. Apparatus as claimed in claim 3, wherein the three discrete sources are controlled to be repeatedly sequenced in time so that only a respective one of said sources is activated to yield an output in each of three time intervals.

5. Apparatus as claimed in claim 3, wherein each source is individually controlled so as to be separately activated by a respective measurand.

6. Apparatus as claimed in claim 1, wherein said source defining means comprises a single broad spectral width source, the colour temperature of which is controlled via sequential switching in time of three different power supply levels so as to provide said three effectively different sources having non-orthogonal spectral outputs.

7. Apparatus as claimed in claim 1, wherein each detector has a respective gain which can be separately time stepped.

8. Apparatus as claimed in claim 1, wherein the detectors comprise three signal detectors.

9. Apparatus as claimed in claim 1, wherein the detectors comprise clusters of three non-orthogonal detectors.

10. Apparatus as claimed in claim 1, wherein the outputs from the detectors are processed to yield chromatic parameters appropriate to the particular application.

11. Apparatus as claimed in claim 10, wherein the processing is arranged to yield Hue, Saturation, Lightness (Hₚ Sₚ Lₚ) parameters or other forms of chromatic parameters.

12. Apparatus as claimed in claim 1, further comprising means for effecting second generation/stage processing on the primary chromatic outputs to yield secondary chromatic processing information.

13. Apparatus as claimed in claim 12, wherein the second generation/stage processing comprises chromatic processing of the primary chromatic parameters in a second different domain, such as time, to yield a further set of chromatic parameters.

14. Apparatus as claimed in claim 1, wherein the modulation means comprises a thermo chromatic element, or liquid or solid whose spectral transmission or reflection varies as a function of temperature whereby to provide transduction from temperature change to spectral change.

15. Apparatus as claimed in claim 1, wherein the modulation means comprises a cell containing optically active chemical, with optical polarising filters disposed at predetermined inclinations to each other whereby different optical wavelengths have their planes of polarisation rotated by different amounts, each of which depends upon the chemical type and concentration so that the spectral signature and hence chemical co-ordinates are indicative of the concentration and type of active components present.

16. Apparatus as claimed in claim 1, wherein the modulation means comprises either particulates, which scatter light of different wavelengths preferentially in different angular directions depending upon their size and concentrations, or compounds which absorb different wavelengths characteristically so affecting the spectral signature, and hence chromatic co-ordinates in defined manners.

17. A method for non-orthogonal monitoring of a variable measurand in a system or process, comprising:
defining at least three sources having limited spectral widths and non-orthogonal spectral outputs;
modulating the outputs of said sources in response to said variable measurand;
passing the modulated outputs of said sources to at least three detectors which have non-orthogonal responsivities in the measurement domain; and
converting the detector outputs algorithmically into primary chromatic parameters.

18. A non-orthogonal processing system having N sources/detectors where N>3, comprising x non-orthogonal detectors and N−x non-orthogonal sources, said detectors and/or said sources, or their operating characteristics, being arranged to be sequentially switched.

19. A non-orthogonal processing system as claimed in claim 18, wherein the sources are discrete.

20. A non-orthogonal processing system as claimed in claim 18, wherein N−x sources are achieved by means of a single physical element which is driven under different conditions to produce correspondingly different wavelength characteristics.
